(19) United States
(12) Patent Application Publication
(10) Pub. No.: US 2006/0167925 A1
(43) Pub. Date: Jul. 27, 2006

(54) System and method for providing system objects to a database

(75) Inventors: Samuel Hyrum Smith, Albuquerque, NM (US); Yixue Zhu, Sammamish, WA (US); Sameer Arun Verkhedkar, Issaquah, WA (US); Clifford Thomas Dibble, Bellevue, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/042,451

(22) Filed: Jan. 24, 2005

(51) Int. Cl. G06F 17/30

(52) U.S. Cl. 707/102

(57) ABSTRACT

A system and method are presented for providing system code to a variety of databases by using a resource database. The resource database contains pre-created system objects, which have been parsed and organized into a format suitable for execution. These pre-created system objects are capable of logically appearing in the variety of databases, while physically persisting in the resource database. Employing the resource database allows for quick upgrades and rollbacks since the pre-created system objects can be copied and installed on computer systems in a single file-copy operation. Additionally, the resource database limits accessibility to its pre-created system objects, thereby ensuring the integrity of the resource database. Lastly, the resource database contains its own metadata that is distinct from the metadata of the variety of databases.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright © 2004, Microsoft Corp.

### FIELD OF THE INVENTION

The present invention relates to a system and method for providing system objects to a variety of databases, and more particularly, to a system and method for providing pre-created system objects that are physically stored in a resource database and that logically appear in the variety of databases.

### BACKGROUND OF THE INVENTION

System objects of databases need to be updated every now and again and sometimes even rolled back to a previous state. System objects include functionalities that are implemented and exposed as T-SQL (Transact-Structured Query Language) objects. Examples of such objects include: views, functions, and stored procedures. Upgrading, rolling back, or undoing system objects in a database running on a server is a time consuming process. During any of these processes, the server is down for tens of minutes because thousands of individual system objects have to be dropped and recreated, that is, deleted and created again. This compromises the availability of the server.

For example, individual database system objects have to be dropped and recreated using execution scripts. If it takes one second to drop and recreate each system object, and there are 1,000 such system objects, it means that the upgrade takes 16 minutes and 40 seconds to complete. This is a long time for a server to be offline and unavailable.

Thus, it would be advantageous to reduce the upgrade time. As described below, one aspect of the present invention involves substituting the dropping and recreation of individual system objects with a single file-copy operation. The single file-copy operation could be carried out using a single resource database containing pre-created system objects that would only need to be installed on a server and thereafter would logically appear in the appropriate databases. Likewise, it would be advantageous to reduce the time for performing the “undo” and “rollback” features of a database, where the resource database could be used to install system objects from a prior version of a server.

Another problem associated with system objects is that users can modify them and build dependencies on them. Modified system objects can become corrupted and unusable. Thus, it would also be desirable to maintain the integrity of system code by making the resource database inaccessible to normal users under normal operating conditions, which would mean that there would be little chance of unauthorized persons making modifications to it or building dependencies on it. However, at the same time it would be desirable to provide some access to the resource database for troubleshooting purposes. For example, such access could be granted in single-user mode or over a dedicated administration connection.

Furthermore, it would be desirable for the system objects that are contained in the resource database to logically “appear” in every other database context, such that pre-created system objects that are physically persisted in the resource database are logically apparent and accessible in every database context. In short, it would be desirable to have a single physical copy of resource database system objects but multiple logical copies, so that the resource database would act like a transparent code library.

### SUMMARY OF THE INVENTION

A system and method are presented for providing system objects to a variety of databases. A presently preferred implementation of the invention employs a resource database. The resource database contains pre-created database system objects that physically persist in the database. These pre-created system objects are capable of logically appearing in other databases. In one aspect of the invention, the resource database stores the pre-created database system objects in such a way that the pre-created system objects are parsed and organized into a format suitable for execution.

The resource database can be copied to a server in a single file copy operation and installed so that the pre-created system objects logically appear on the variety of databases. This single file copy operation allows for quick upgrades, rollbacks, and any other desired modifications to the system objects, without needing to drop and recreate thousands of individual system objects, e.g., using SQL execution scripts. Obviating the need to execute individual system objects and instead performing a single file copy operation leads to substantial savings in time that it takes to upgrade, rollback, or otherwise modify a database server.

Additionally, in the presently preferred aspect of the invention, the pre-created system objects are inaccessible to a typical database user when the user is operating in multi-user mode, so that the user cannot make modifications to the pre-created system objects. However, the pre-created system objects are made accessible in single-user mode and over a dedicated administration connection to allow for troubleshooting and support.

Lastly, the resource database may contain its own metadata, where the resource database metadata describes the pre-created system objects. Likewise, the variety of databases where resource database system objects logically appear may contain their own metadata, including tables, views, stored procedures, and the like.

### BRIEF DESCRIPTION OF THE DRAWINGS

The foregoing summary, as well as the following detailed description of the invention, is better understood when read in conjunction with the appended drawings. In order to illustrate the invention, exemplary embodiments are shown depicting various aspects of the invention. However, the invention is not limited to the specific systems and methods disclosed. The following figures are included:

FIG. 1A provides a schematic diagram of an exemplary-networked or distributed computing environment;

FIG. 1B provides a brief general description of a suitable computing device in connection with which the invention may be implemented;

FIG. 2A illustrates the upgrading of system objects using T-SQL execution scripts by dropping and recreating numerous system objects;

FIG. 2B illustrates the upgrading of system objects using the resource database;

FIG. 3 illustrates the inaccessibility of resource database system objects in multi-user mode and accessibility in single-user mode and over a dedicated administration connection;

FIG. 4 illustrates the logical and physical relationships between different kinds of databases and the resource database;

FIG. 5 illustrates the location of the resource database metadata and the metadata of typical databases; and

FIG. 6 presents a flow chart of how a typical resource database may be used.

### DETAILED DESCRIPTION OF ILLUSTRATIVE EMBODIMENTS

The subject matter of the present invention is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

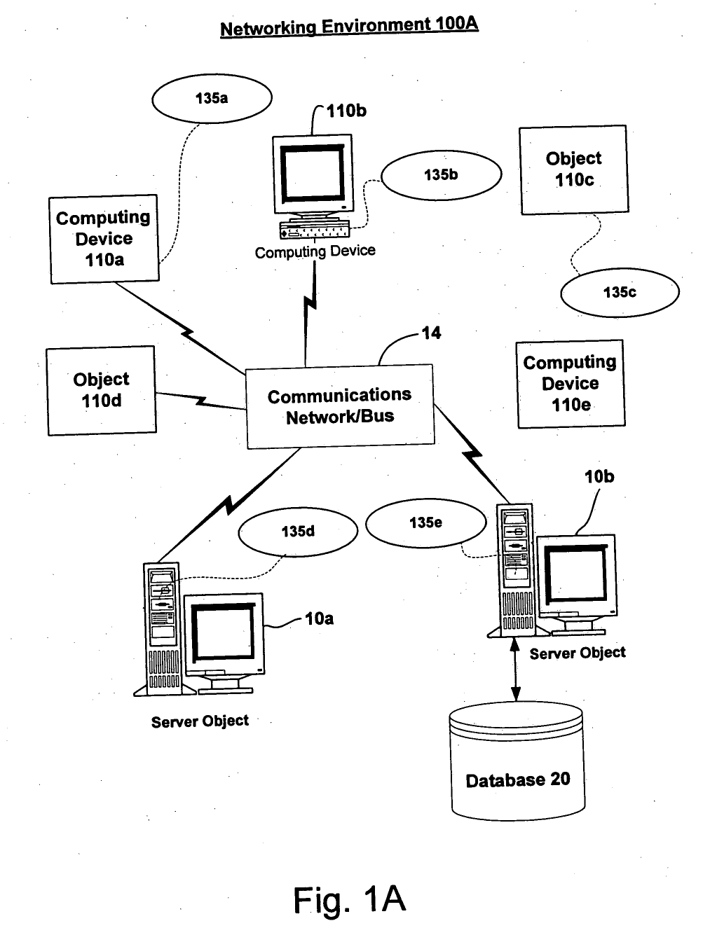

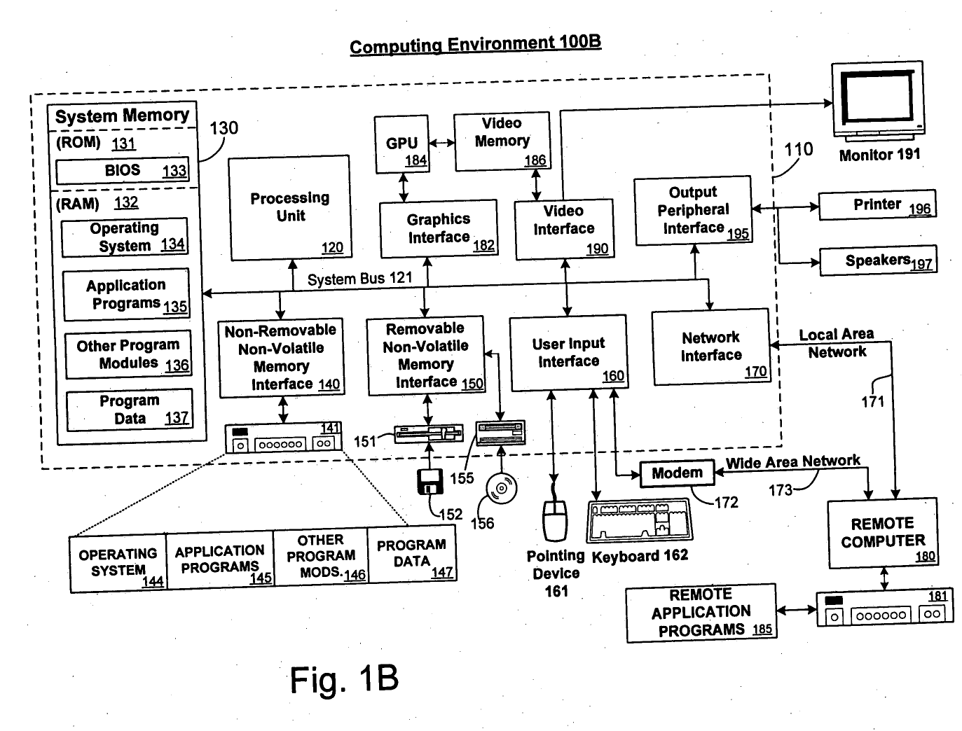

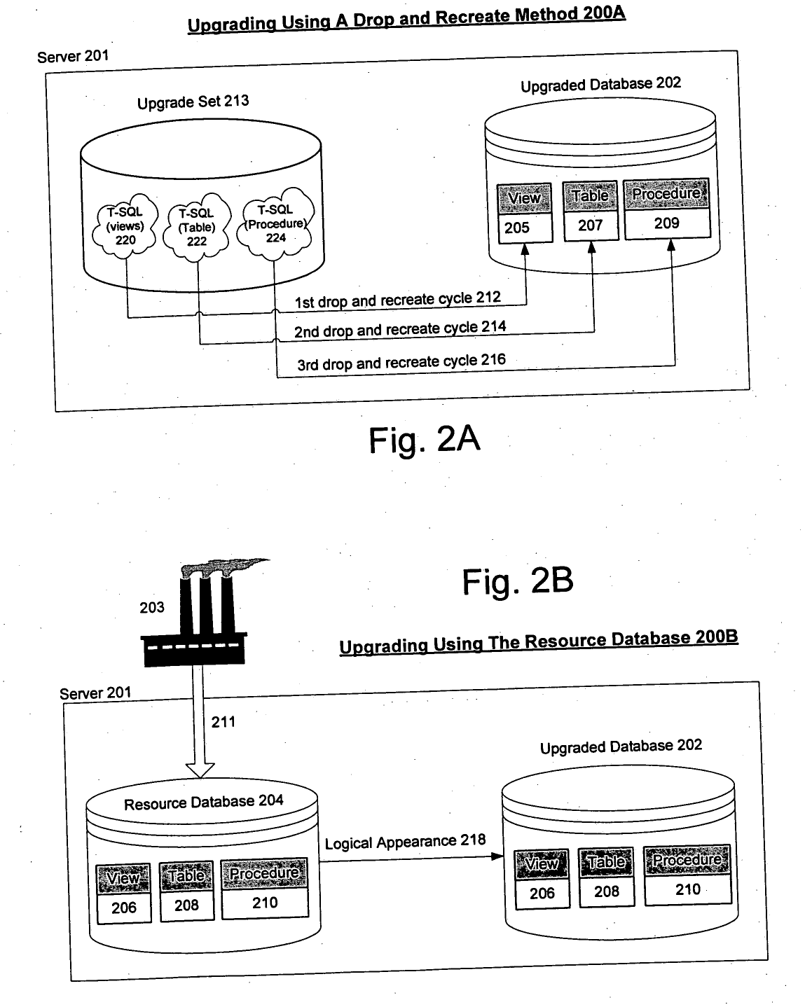

The following description is divided into two parts. First, a sample networking and computing environment is discussed that may be applicable to the invention. This environment is illustrated in FIGS. 1A and 1B. Second, aspects of the invention itself are discussed. These aspects are illustrated in FIGS. 2A-B and 3-6.

Networking and Computing Environment

FIG. 1A provides a schematic diagram of an exemplary networked or distributed computing environment 100A. The distributed computing environment 100A comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, televisions, MP3 players, personal computers, etc. Each object can communicate with another object by way of the communications network 14. This network may itself comprise other computing objects and computing devices that provide services to the system of FIG. 1A, and may itself represent multiple interconnected networks. In accordance with an aspect of the invention, each object 10a, 10b, etc. or 110a, 110b, 110c, etc. may contain an application that might make use of an API, or other object, software, firmware and/or hardware, to request use of the processes used to implement the object persistence methods of the present invention.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments 100A. For example, computing systems may be connected together by wired or wireless systems, by local networks or widely distributed networks. Currently, many of the networks are coupled to the Internet, which provides the infrastructure for widely distributed computing and encompasses many different networks. Any of the infrastructures may be used for exemplary communications made incident to the present invention.

The Internet commonly refers to the collection of networks and gateways that utilize the TCP/IP suite of protocols, which are well-known in the art of computer networking. TCP/IP is an acronym for “Transmission Control Protocol/Internet Protocol.” The Internet can be described as a system of geographically distributed remote computer networks interconnected by computers executing networking protocols that allow users to interact and share information over the network(s). Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 1A, computers 110a, 110b, etc. can be thought of as clients and computer 10a, 10b, etc. can be thought of as servers, although any computer could be considered a client, a server, or both, depending on the circumstances. Any of these computing devices may be processing data in a manner that implicates the object persistence techniques of the invention.

A server is typically a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the persistence mechanism of the invention may be distributed across multiple computing devices.

Client(s) and server(s) may communicate with one another utilizing the functionality provided by a protocol layer. For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over any available communications medium.

Thus, FIG. 1A illustrates an exemplary networked or distributed environment 100A, with a server in communication with client computers via a network/bus, in which the present invention may be employed. The network/bus 14 may be a LAN, WAN, intranet, the Internet, or some other network medium, with a number of client or remote computing devices 110a, 110b, 110c, 110d, 110e, etc., such as a protable computer, handheld computer, thin client, networked appliance, or other device, such as a VCR, TV, oven, light, heater and the like in accordance with the present invention. It is thus contemplated that the present invention may apply to any computing device in connection with which it is desirable to maintain a persisted object.

In a network environment 100A in which the communications network/bus 14 is the Internet, for example, the servers 10a, 10b, etc. can be servers with which the clients 110a, 110b, 110c, 110d, 110e, etc. communicate via any of a number of known protocols such as HTTP. Servers 10a, 10 b, etc. may also serve as clients 110a, 110b, 110c, 110d, 110e, etc., as may be characteristic of a distributed computing environment 100A.

Communications may be wired or wireless, where appropriate. Client devices 110a, 110b, 110c, 110d, 110e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 110e, etc. and server computer 10a, 10b, etc. may be equipped with various application program modules or objects 135 and with connections or access to various types of storage elements or objects, across which files or data streams may be stored or to which portion(s) of files or data streams may be downloaded, transmitted or migrated. Any computer 10a, 10b, 110a, 110b, etc. may be responsible for the maintenance and updating of a database, memory, or other storage element 20 for storing data processed according to the invention. Thus, the present invention can be utilized in a computer network environment having client computers 110a, 110b, etc. that can access and interact with a computer network/bus 14 and server computers 10a, 10b, etc. that may interact with client computers 110a, 110b, etc. and other like devices, and databases 20.

FIG. 1B and the following discussion are intended to provide a brief general description of a suitable computing environment 100B in connection with which the invention may be implemented. For example, any of the client and server computers or devices illustrated in FIG. 1B may take this form. It should be understood, however, that handheld, portable and other computing devices and computing objects of all kinds are contemplated for use in connection with the present invention, i.e., anywhere from which data may be generated, processed, received and/or transmitted in a computing environment 100B. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved or transmitted to another computer is a desirable, or suitable, environment for operation of the object persistence methods of the invention.

Although not required, the invention can be implemented via an operating system, for use by a developer of services for a device or object, and/or included within application or server software that operates in accordance with the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like.

FIG. 1B thus illustrates an example of a suitable computing system environment 100B in which the invention may be implemented, although as made clear above, the computing system environment 100B is only one example of a suitable computing environment and is not intended to suggest any limitation as to the scope of use or functionality of the invention. Neither should the computing environment 100B be interpreted as having any dependency or requirement relating to any one or combination of components illustrated in the exemplary operating environment 100B.

With reference to FIG. 1B, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA).local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read-only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1B illustrates operating system 134, application programs 135, other program modules 136, and program data 137.

The computer 110 may also include other removable/non-removable, volatile/nonvolatile computer storage media. By way of example only, FIG. 8 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1B provide storage of computer readable instructions, data structures, program modules and other data for the computer 110. In FIG. 1B, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1B. The logical connections depicted in FIG. 1B include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1B illustrates remote application programs 185 as residing on memory device 181. It will be appreciated that the network connections shown are exemplary and other means of establishing a communications link between the computers may be used.

Overview of The Resource Database

The resource database is a deployment and delivery mechanism for T-SQL system code. Broadly speaking, the resource database contains pre-created system objects, which are parsed and organized into a format suitable for execution. These pre-crated system objects can be installed all at once on a server or on any computer system and then be available for any other databases to use. This feature allows for quick upgrades of vendor supplied system objects and for quick rollbacks to prior versions of system objects.

Once installed, the resource database acts as a read-only library of system objects. In fact, the resource database can be thought of as a kind of dynamic link library (DLL). In other words, it is to a SQL Server's T-SQL what a DLL is to a SQL server's C++ code. Because the resource database acts as a read-only library, various databases can utilize its system objects, but, generally speaking, the system objects cannot be altered. Disallowing alteration of system objects protects the integrity of the system code, since customers are not able to modify the system objects and build dependencies on them.

Although the resource database is not a directly accessible user-level feature, it nonetheless influences the overall behavior of many other features and aspects of system operation that are accessible and observable to the user. There are many inter-dependencies between the resource database and other features of a. database. Thus, because the resource database is a piece of infrastructure and “plumbing,” it is not accessible in multi-user mode in order to protect the integrity of system objects. However, it is accessible in single-user mode and over a dedicated administration connection to allow for troubleshooting and support.

To install a new resource database, a server is typically temporarily stopped while the resource database is put into place. The reason for the stoppage is that the resource database contains vital system code that may be necessary to the operation of the server. This is no different than if an EXE or DLL file were to be replaced. The overall time of unavailability of the server will be on the order of seconds or tens of seconds because the resource database can be copied onto the server in a single file copy operation and then be immediately installed.

This fast installation time of the resource database allows for quick upgrades and rollbacks, and stands in stark contrast to an upgrade/rollback mechanism where thousands of T-SQL statements contained in scores of scripts are used to drop and recreate system objects. Such drop and recreate mechanisms typically require tens of minutes to execute. As such, they take several times longer to implement than the resource database.

Lastly, the resource database is a major infrastructure component of the SQL Server, but it is not limited to the SQL server architecture, since the general concepts described herein are extendible to other types of database servers. In short, the resource database represents a major architectural change from all previous versions of database upgrade and rollback systems relating to system objects. Additionally, it has the benefit of protecting the integrity of system objects by limiting accessibility to them.

Aspects of the Resource Database

FIG. 2A illustrates one possible way to perform the upgrading of system objects, using a drop and recreate method 200A. Given an upgrade set 213, containing various T-SQL scripts, a database 202 on a server 201 can be upgraded. The upgrade set 213 contains T-SQL scripts for upgrading views, tables, stored procedures, and any other system objects. For example, one set of T-SQL scripts 220 can drop and recreate 212 the views 205 in a database in order to upgrade them. Likewise, another set of T-SQL scripts 222 can be used to drop and recreate 214 the tables 207 in the upgraded database 202. And yet a third T-SQL script set 224 can be used to drop and recreate 216 the stored procedures 209 in the upgraded database 202, and so on.

For example, the following represents a typical drop statement in T-SQL, where a view is dropped:
DROP VIEW {view}[, . . . n]
   The DROP VIEW statement removes the view from the current database, and it can be executed against indexed views. The “view” in the brackets is the name of the view to be removed, and the “n” is a placeholder indicating that multiple views can be specified.

In the same vein, the following represents a typical create statement in T-SQL, where a view is created or recreated:

CREATE VIEW [<schema name> . ] view_name [ ( column [ ,...n ] ) ]
[ WITH < view_attribute > [ ,...n ] ]
AS
select_statement
[ WITH CHECK OPTION ]
< view_attribute > ::=
{ ENCRYPTION | SCHEMABINDING | VIEW_METADATA }

The CREATE VIEW statement creates a virtual table that represents the data in one or more tables in an alternative way. The CREATE VIEW must be the first statement in a query batch.

The “schema name” argument stands for the name of the schema or namespace that contains the view. The argument “view_name” is the name of the view. View names must follow the rules for identifiers. The “column” argument is the name to be used for a column in a view. Naming a column in CREATE VIEW is necessary only when a column is derived from an arithmetic expression, a function, or a constant, when two or more columns may otherwise have the same name (usually because of a join), or when a column in a view is given a name different from that of the column from which derived. And, as before, “n” is a placeholder that indicates that multiple columns can be specified.

The other statements further specify what is to be done during the CREATE process. In short, the “AS” statement represents the action the view is to perform; the “select_statement” is a SELECT statement that defines the view; “WITH CHECK OPTION” forces all data modification statements executed against the view to adhere to the criteria set within “select_statement”; “WITH ENCRYPTION” indicates encryption of system table columns containing the text of the CREATE VIEW statement; “SCHEMABINDING” binds the view to the schema; and finally, “VIEW_METADATA” specifies that metadata information about the view will be returned. As mentioned, the CREATE statement and the DROP statement, mentioned in the previous paragraph, represent the typical T-SQL statements that can be used to upgrade system objects.

In contrast to FIG. 2A, however, FIG. 2B presents an alternative way to upgrade system objects that also reflects one aspect of the present invention, namely, upgrading by using the resource database 200B. In FIG. 2B, the system objects are already pre-created and therefore don't need to be dropped and recreated. Specifically, the views 206, tables 208, and stored procedures 210 are pre-created and stored in the resource database 204 at the point of manufacture 203. All that it takes to upgrade a database 202 is for the resource database 204 to be deployed 211 from the manufacturer 203 and installed on a server 201. Once installed, the resource database's 204 system objects, that is, its views 206, tables 208, stored procedures 208, etc., will logically appear 218 in a database 202, as the database's 202 views 206, tables 208, and stored procedures 210.

In order to upgrade system objects in a database, new objects representing the upgrade must be installed. As mentioned, one way to perform the upgrade is to execute T-SQL scripts 220, 222, and 224 as shown in FIG. 2A. An alternative way to upgrade is to use pre-created system objects, such as views 206, tables 208, and stored procedures 210 in a resource database, as shown in FIG. 2B. This latter upgrade mechanism which uses the resource database, changes the installation model from one of drop and create to one of file copy. Thus, instead of dropping and creating system objects, pre-created system objects in the resource database can be copied in a single operation on a server and installed to upgrade the system objects of a database. The file copy mechanism enables faster installs because a file copy is much faster than executing T-SQL scripts that drop and create thousands of system objects.

The resource database also allows for easier rollbacks of QFE (Quick Fix Engineering) or service packs because an older version of the resource database can simply be copied back into place. Thus, prior to this rollback aspect of the invention, rollback entailed another drop and create cycle, just as in the upgrade case, except in reverse. With the resource database there is an efficient and effective way to rollback a given QFE or service pack, namely by avoiding the consuming drop and create process and instead using a file copy operation, as described above.

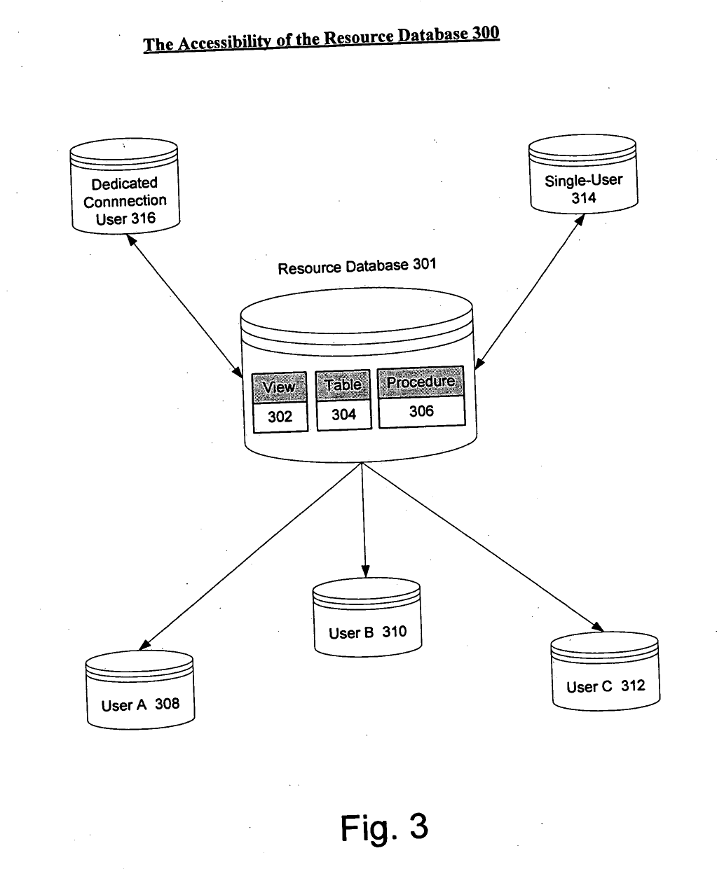

In another aspect of the invention, FIG. 3 illustrates the accessibility of the resource database 300. In FIG. 3, a resource database 301 has stored within it system objects such as views 302, tables 304, and procedures 306. These system objects are accessible in multiple user mode to multiple users, such as user A 308, user B 310, and user C 312. However, this accessibility is limited to read-only mode, where any one of the multiple users can read the resource database's system objects but cannot modify them. Such inaccessibility means that users will not have the opportunity to corrupt resource database system objects or to build dependencies on modified system objects. This read-only relationship is illustrated with one way arrows, where the arrows indicate that the resource database 301 system objects 302, 304, and 306 are accessible to the multiple users 308, 310, and 312, but these users cannot make any changes to the system objects.

In contrast to the multiple-user mode, the resource database 301 is accessible in single-user mode and over a dedicated administration connection. FIG. 3 illustrates a single-user 314 in single-user mode. As the two way arrow between the resource database 301 and the single-user 314 suggests, the single-user 314 can not only access the system objects 302, 304, and 306 as a typical user would in multiple-user mode, but can additionally modify the system objects in the resource database 301 if there is a need for troubleshooting or some modification. Similar explanation applies to the dedicated connection user 316, except that if a server is in multi-user mode a database administrator connecting to such a server would gain read-only access to the base tables of the resource database—otherwise, such an administrator would have read and write access.

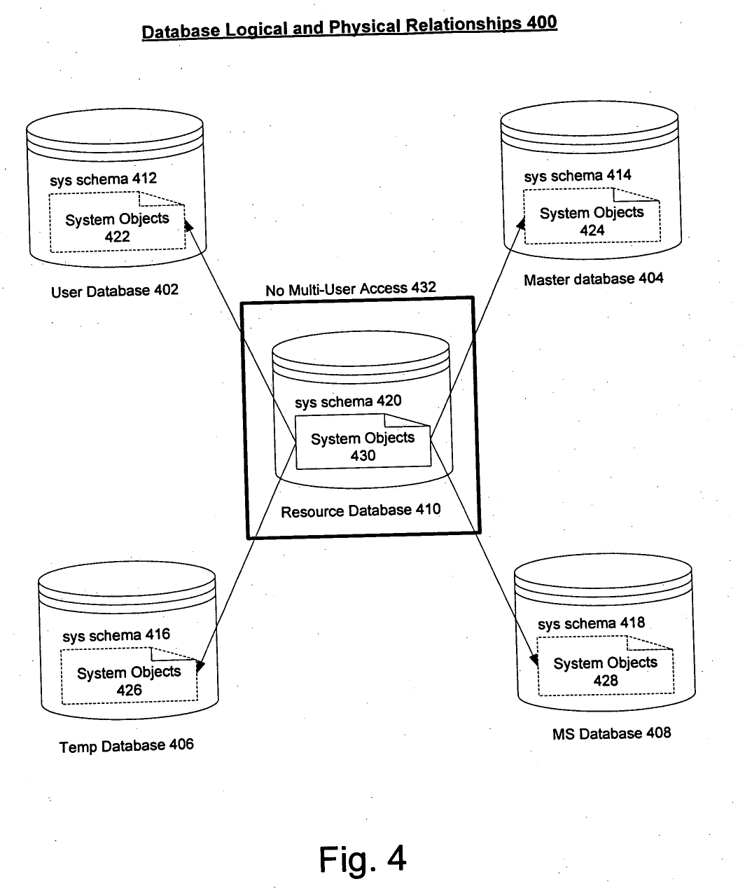

In yet another aspect of the invention, in FIG. 4, database logical and physical relationships 400 are illustrated between different kinds of databases and the resource database 410. The different kinds of databases include but are not limited to: a user database 402, a master database 404, a temp database 406, and a MS database 408. The user database, as the name suggests, stores a typical user's data; the master database records all of the system level information for a server system; the temp database holds all the temporary tables, temporary views, and temporary stored procedures; and, the MS database stores server data, including scheduling information and backup and restore history information.

The system objects 430 physically persist in the resource database 410, but logically appear in the “sys schema” of every other database, namely, databases 402, 404, 406, and 408. In other words, system objects 430 are physically stored in the sys schema 420 of the resource database 410, but they logically appear in schema 412 of the user database 402 as logical system objects 422; they logically appear in the schema 414 of the master database 404 as logical system objects 424; they logically appear in the schema 416 of the temp database 406 as logical system objects 426; and, they logically appear in the schema 418 of the MS database 408 as logical system objects 428.

This logical and physical relationship is illustrated with a solid line used to illustrate the resource database 410 sys schema 420 that has the physical embodiment of the system objects 430 and, conversely, dashed lines representing the sys schema of the other databases, namely, 412, 414, 416, and 418 that only have the logical copy 422, 424, 426, and 428 of the system objects 430. Moreover, the solid line 432 around the resource database 410 illustrates the idea that the resource database 410 is not accessible in multi-user mode, and that it is not meant for customer access. Also, the one-way arrows going from the resource database 410 to the other databases 402, 404, 406, and 408, further suggests that the access is one-way: system objects 430 appear in the other databases 402, 404, 406, and 408 but the these databases don't have access to the resource database 410.

As mentioned, pre-created system objects are physically contained in the resource database 410. The term “pre-created” means that all the constituent T-SQL “CREATE . . . ” statements have been parsed and organized into a format suitable for execution. In essence, each “CREATE” statement is executed at the factory, where the T-SQL text is parsed, analyzed, and validated, and a metadata representation of system objects is constructed and persisted into the resource database's catalog. In short, the system objects are parsed and ready to be used as customer queries and batches which are complied and executed at run time.

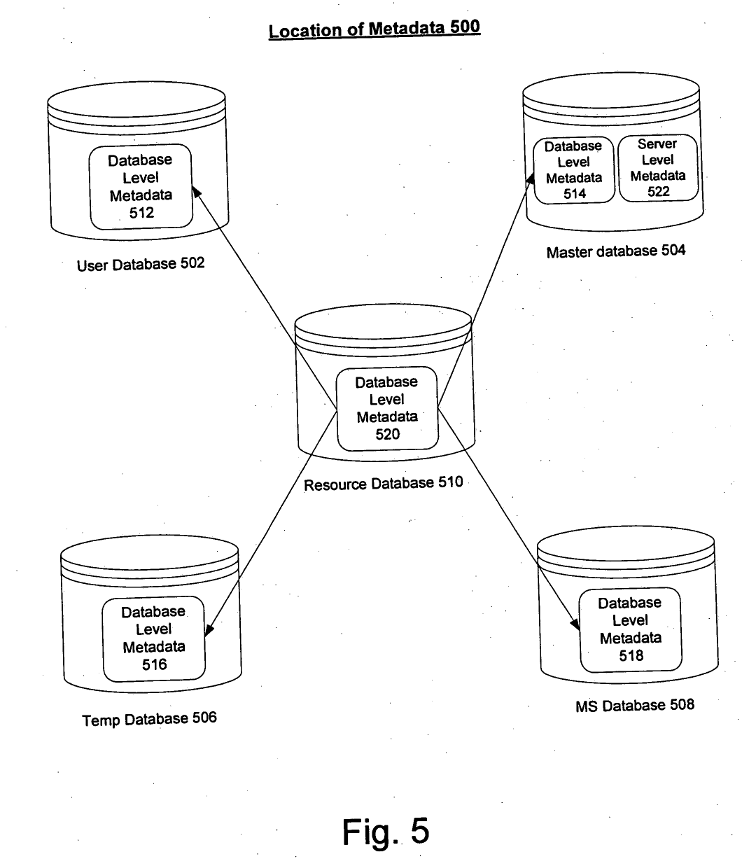

In another aspect of the invention, FIG. 5 illustrates the location of database metadata 500. The resource database 510 does not contain the metadata of other databases, namely, user database 502, master database 504, temp database 506, and MS database 508. In fact, each database that uses the resource database 510 contains its own metadata—just as before the implementation of the resource database 510. Thus, the user database 502 has its own metadata 512, the master database 504 has its own metadata 514, the temp database 506 has its own metadata 516, and the MS database has its own metadata 518. If this were not so, there would be no way for one to detach and reattach, or backup and restore individual databases. However, the master database 504 is unique in that it also contains instance-wide metadata, concerning logins, endpoints, and linked servers, which is illustrated as server level metadata 522.

The resource database also contains metadata 520. This resource database metadata 520 describes the pre-created system objects. While the metadata 512 in a user database 502 describes the user's tables, views, procedures, primary keys, and so forth, the resource database 510 metadata 520 describes the system objects that are accessible to every application in every database, since they are logically apparent and accessible in the “sys” schema of every database.

Finally, it is worth noting that the metadata in each database has the same underlying structure composed of tables, index, constraints, and so on. That is to say, there is a common underlying schema that captures database metadata, regardless of whether it is the user database, the temp database, the mater database, or even the resource database itself.

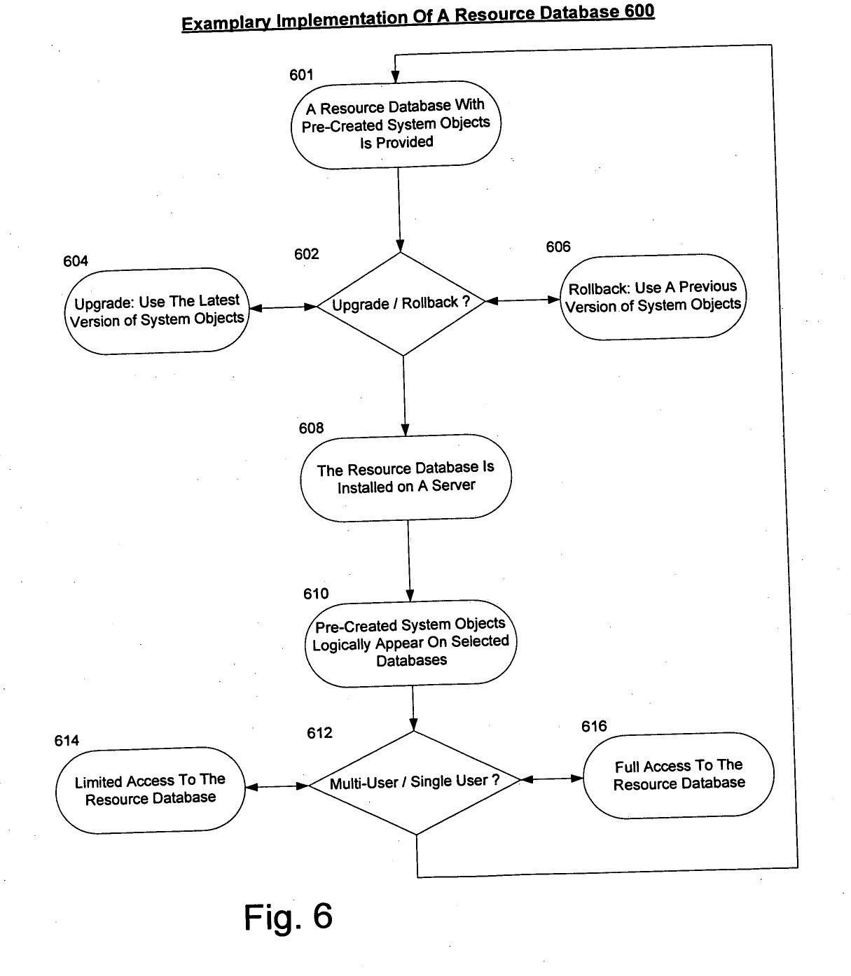

FIG. 6 illustrates one aspect of how the resource database may be implemented 600. At step 601, a resource database is provided. It contains the requisite pre-created system objects that have been parsed and organized into a format suitable for execution. As mentioned above, these pre-crated system objects comprise tables, views, stored procedures and any other code necessary for a database system. At this point, the resource database may be deployed by a manufacturer via a single file copy operation and saved on a server to be used either for an upgrade or a rollback function. This decision is illustrated in step 602.

At step 604, the resource database is used for an upgrade, which means that the latest version of system objects will be provided to databases using the resource database. At step 606, the opposite can happen, namely, a rollback can be enacted so that a previous version of system objects contained in the resource database can be provided to the appropriate database.

Once a decision is made as to upgrade or rollback system objects, the resource database can be installed on a server 608 so that the system object will logically appear on selected databases 610. As mentioned above, the system objects physically persist at all times in the resource database, but they logically appear on selected databases. Such logical appearance means that the resource database system objects are read-only objects for the selected databases, even though they are vital and fundamental to those databases.

Finally, at step 612 it is determined whether the server is in multi-user mode or single-user mode. If the former, at step 614, the normal user in this mode can obtain limited access. In other words, such a user can: (1) execute or select from system objects, (2) see the system objects in the database catalog, but cannot either (3) read the SQL definitions of system objects from the base tables of the resource database nor (4) write or modify the SQL definitions of system objects form the base tables of the resource database. On the other hand, at step 616, the user in single-user mode can obtain full access to the resource database, which means that he can perform all four of the functionalities listed above.

After a decision is made to grant the type of access to the system objects in the resource database, the resource database continues to provide system objects to the databases where the system objects logically appear. Lastly, step 612, the exemplary implementation loops back to step 601 to await for a new resource database to be provided, either to upgrade or rollback system objects.

While the present invention has been described in connection with the various aspects, as illustrated in the various figures, it is understood that other similar aspects may be used or modifications and additions may be made to the described aspects for performing the same function of the present invention without deviating therefrom. For example, while a resource database was described, where the resource database contains pre-created system objects that physically persist in the resource database but logically appear in other databases, other equivalent upgrading or rolling back mechanism consistent with the notion of a resource database may be employed. Therefore, the present invention should not be limited to any single aspect, but rather construed in breadth and scope in accordance with the appended claims.

What is claimed:

1. A system for deploying and modifying database system code, comprising:
a first database containing pre-created system objects that physically persist in the first database; and
a second database, wherein the pre-created system objects in the first database logically appear in the second database.

2. The system according to claim 1, wherein the first database and the second database are Structured Query Language server databases.

3. The system according to claim 1, further comprising a server, wherein the first database is copied to the server in a file copy operation, and wherein upon installation of the first database on the server, the pre-created system objects logically appear in the second database.

4. The system according to claim 1, wherein the pre-created system objects in the first database are parsed and organized into a format suitable for execution.

5. The system according to claim 1, wherein the first database contains first database metadata and the second database contains second database metadata, wherein the first database metadata is distinct from the second database metadata.

6. The system according to claim 1, wherein the first database is a resource database that provides upgrades and rollbacks of a set of system objects used by the second database, wherein the pre-created system objects replace the set of system objects.

7. The system according to claim 1, wherein the pre-crated database system objects are accessible in a first mode and a second mode, wherein the first mode is a read-only mode and the second mode is a read and write mode.

8. A method for modifying system objects in databases, comprising:
obtaining a first database, wherein the first database includes pre-created database system objects that physically persist in the first database; and
installing the first database, wherein the pre-created system objects logically appear in a second database.

9. The method according to claim 8, wherein the first database and the second database are Structured Query Language server databases.

10. The method according to claim 8, wherein the first database is obtained in a file copy operation.

11. The method according to claim 8, wherein the first database pre-created system objects are parsed and organized into a format suitable for execution.

12. The method according to claim 8, wherein the first database contains first database metadata and the second database contains second database metadata, wherein the first database metadata is distinct from the second database metadata.

13. The method according to claim 8, wherein the first database is a resource database that provides upgrades and rollbacks of a set of system objects used by the second database, wherein the pre-created system objects replace the set of system objects.

14. The method according to claim 8, wherein the pre-crated database system objects are accessible in a first mode and a second mode, wherein the first mode is a read-only mode and the second mode is a read and write mode.

15. A method for deploying system code to a computer database, comprising:
obtaining a resource database that physically contains pre-created system code; and
supplying the resource database, wherein the pre-created system code is capable of logically appearing in the computer database.

16. The method according to claim 15, wherein the resource database pre-created system code is parsed and organized into a format suitable for execution.

17. The method according to claim 15, wherein supplying the resource database includes copying the resource database using a file copy operation.

18. The method according to claim 15, wherein the resource database is installed on a server, wherein the pre-created system code logically appears in the computer database.

19. The method according to claim 15, wherein the resource database provides upgrades and rollbacks of a set of system objects used by the computer database, wherein the pre-created system objects replace the set of system objects.

20. The method according to claim 15, wherein the pre-crated database system objects are accessible in a first mode and a second mode, wherein the first mode is a read-only mode and the second mode is a read and write mode.
